(19) United States
(12) Patent Application Publication
(10) Pub. No.: US 2021/0287549 A1
(43) Pub. Date: Sep. 16, 2021

(54) VEHICLE DISPATCH SERVICE DEVICE, VEHICLE DISPATCH SERVICE METHOD, AND NON-TRANSITORY COMPUTER-READABLE MEDIUM STORING PROGRAM

(71) Applicant: HONDA MOTOR CO., LTD., Tokyo (JP)

(72) Inventor: Yoshikazu NISHIDA, Saitama (JP)

(21) Appl. No.: 17/192,905

(22) Filed: Mar. 5, 2021

(30) Foreign Application Priority Data
Mar. 10, 2020 (JP) 2020-040894

(51) Int. Cl. G08G 1/00; B60L 58/12; G07C 5/00

(52) U.S. Cl. CPC G08G 1/202; G07C 5/008; B60L 58/12

(57) ABSTRACT

A vehicle dispatch service device 100 includes: a determination unit 130 that determines whether a service of dispatching an electric vehicle 200 capable of supplying a power source is able to be provided in response to a request for supply of electricity from a user, on the basis of a vehicle request received by a communication unit 110 from a terminal device 300 of the user U and vehicle notification information 164 stored in a storage unit 160 and including vehicle dispatch approval/disapproval information; and a management unit 140 that outputs information instructing dispatch of the electric vehicle 200 determined to be capable of providing the vehicle dispatch service if the determination unit 130 determines that the service of dispatching the electric vehicle 200 is able to be provided.

This application is based on and claims the benefit of priority from Japanese Patent Application No. 2020-040894, filed on 10 Mar. 2020, the content of which is incorporated herein by reference.

### BACKGROUND OF THE INVENTION

### Field of the Invention

The present invention relates to a vehicle dispatch service device, a vehicle dispatch service method, and a non-transitory computer-readable medium storing a program.

### Related Art

There have recently been known electric vehicles caused to travel by electric motors driven by electric power supplied from secondary cells (batteries). Such electric vehicles include battery electric vehicles (BEVs), hybrid electric vehicles (HEVs), plug-in hybrid electric vehicles (PHEVs), fuel cell vehicles (FCVs), and plug-in fuel cell vehicles (PFCVs).

A technique wherein a plurality of users use the same common vehicle is known in relation to a service using vehicles (see patent document 1, for example).

Patent Document 1: Japanese Unexamined Patent Application, Publication No. 2003-6294

### SUMMARY OF THE INVENTION

Supply of electricity is required in places where there is difficulty in supplying electricity such as riverside barbecue places, regions of emergency area power outages, and open-air live venues, for example.

An object of the present invention is to provide a vehicle dispatch service device, a vehicle dispatch service method, and a non-transitory computer-readable medium storing a program allowing dispatch of a vehicle capable of supplying electricity in a place where there is difficulty in supplying electricity.

To attain the foregoing object, an aspect of the present invention provides a vehicle dispatch service device (vehicle dispatch service device 100 described later, for example) including: a communication unit (communication unit 110 described later, for example) that makes communication with a vehicle-installed communication device (vehicle-installed communication device 282 described later, for example) and with a terminal device (terminal device 300 described later, for example) of a user (user U described later, for example); an acceptance unit (acceptance unit 120 described later, for example) that stores vehicle notification information (vehicle notification information 164 described later, for example) received by the communication unit into a storage unit (storage unit 160 described later, for example), the vehicle notification information including identification information about an electric vehicle (electric vehicle 200 described later, for example), positional information about the electric vehicle, and information indicating a charging state of the electric vehicle; a determination unit (determination unit 130 described later, for example) that determines whether a service of dispatching an electric vehicle capable of supplying a power source is able to be provided in response to a request for supply of electricity from the user, on the basis of a vehicle request received by the communication unit from the terminal device of the user and the vehicle notification information stored in the storage unit and including vehicle dispatch approval/disapproval information; and a management unit (management unit 140 described later, for example) that outputs information instructing dispatch of the electric vehicle determined to be capable of providing the vehicle dispatch service if the determination unit determines that the service of dispatching the electric vehicle is able

Another aspect of the present invention provides a vehicle dispatch service method implemented by a vehicle dispatch service device including a communication unit that makes communication with a vehicle-installed communication device and with a terminal device of a user. The method includes: storing vehicle notification information received by the communication unit into a storage unit, the vehicle notification information including identification information about an electric vehicle, positional information about the electric vehicle, and information indicating a charging state of the electric vehicle; determining whether a service of dispatching an electric vehicle capable of supplying a power source is able to be provided in response to a request for supply of electricity from the user, on the basis of a vehicle request received by the communication unit from the terminal device of the user and the vehicle notification information stored in the storage unit and including vehicle dispatch approval/disapproval information; and outputting information instructing dispatch of the electric vehicle determined to be capable of providing the vehicle dispatch service if the vehicle dispatch service is determined to be able to be provided.

Yet another aspect of the present invention provides a non-transitory computer-readable medium storing a program for causing a vehicle dispatch service device to perform a process. The vehicle dispatch service device includes a communication unit that makes communication with a vehicle-installed communication device and with a terminal device of a user. The process includes: storing vehicle notification information received by the communication unit into a storage unit, the vehicle notification information including identification information about an electric vehicle, positional information about the electric vehicle, and information indicating a charging state of the electric vehicle; determining whether a service of dispatching an electric vehicle capable of supplying a power source is able to be provided in response to a request for supply of electricity from the user, on the basis of a vehicle request received by the communication unit from the terminal device of the user and the vehicle notification information stored in the storage unit and including vehicle dispatch approval/disapproval information; and outputting information instructing dispatch of the electric vehicle determined to be capable of providing the vehicle dispatch service if the service of dispatching the electric vehicle is determined to be able to be provided.

Thus, it becomes possible to devise a match between a user requesting supply of electricity in a place where there is difficulty in supplying electricity such as a riverside barbecue place, a region of an emergency area power outage, or an open-air live venues, for example, and an electric vehicle capable of supplying electricity. As a result, it becomes possible to supply electricity in the place where there is difficulty in supplying electricity, while an owner of the electric vehicle to supply electricity is allowed to obtain a reward for supply of electricity.

In this case, the determination unit preferably determines whether a required number of electric vehicles is able to be dispatched in response to the request for supply of electricity from the user. This allows the user to be notified of whether the number of vehicles required to satisfy the request from, the user is able to be dispatched. As a result, the user becomes capable of seeing whether the user can actually request vehicle dispatch.

In this case, the vehicle request includes reward information about a reward for the electric vehicle. This allows an owner of the electric vehicle to determine whether vehicle dispatch approval/disapproval information about the electric vehicle is to be “approval” or “disapproval” information by taking the reward information into consideration.

The present invention allows provision of a vehicle dispatch service device, a vehicle dispatch service method, and a non-transitory computer-readable medium storing a program allowing dispatch of a vehicle capable of supplying electricity in a place where there is difficulty in supplying electricity.

### BRIEF DESCRIPTION OF THE DRAWINGS

FIG. 1 is a view of a vehicle system including a vehicle dispatch service device according to an embodiment of the present invention;

FIG. 2 shows the configuration of an electric vehicle that is not a self-driving vehicle to be dispatched by the vehicle dispatch service device according to the embodiment of the present invention;

FIG. 3 shows the configuration of an electric vehicle that is a self-driving vehicle to be dispatched by the vehicle dispatch service device according to the embodiment of the present invention;

FIG. 4 shows an example of vehicle information about an electric vehicle to be dispatched by the vehicle dispatch service device according to the embodiment of the present invention;

FIG. 5 shows an example of user information about a user of the vehicle dispatch service device according to the embodiment of the present invention;

FIG. 6 shows an example of vehicle notification information in the vehicle dispatch service device according to the embodiment of the present invention; and

FIG. 7 is a flowchart showing control relating to the vehicle dispatch service device according to the embodiment of the present invention.

### DETAILED DESCRIPTION OF THE INVENTION

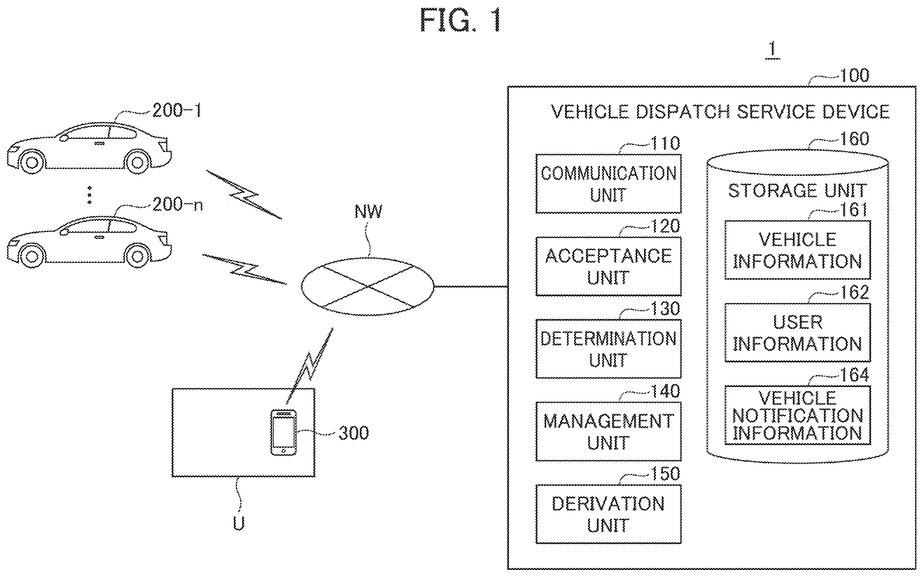

An embodiment of the present invention will be described in detail below by referring to the drawings. FIG. 1 is a view of a vehicle system 1 including a vehicle dispatch service device 100 for vehicle dispatch to places where there is difficulty in supplying electricity such as riverside barbecue places, regions of emergency area power outages, and open-air live venues, for example. In the embodiment described below, an open-air live venue is described as an example of a place where there is difficulty in supplying electricity.

The vehicle system 1 of the embodiment includes the vehicle dispatch service device 100, electric vehicles 200-1 to 200-n (n is an integer of greater than 1), and one or more terminal devices 300 used by one or more users U. “Being used by the user U” may include a case where the user U temporarily uses a terminal device that can be used by an unspecified large number of people such as a terminal device at an Internet cafe.

The vehicle dispatch service device 100, each of the electric vehicles 200-1 to 200-n, and the one or more terminal devices 300 are communicable with each other through a network NW. The network NW includes the Internet, a wide area network (WAN), a local area network (LAN), a public line, a provider device, a dedicated line, a wireless base station, etc. In the embodiment, each of the electric vehicles 200-1 to 200-n stop at parking lots used by respective owners of the electric vehicles 200-1 to 200-n.

The user U is a company holding an open-air live performance at an open-air live venue, for example. In response to an instruction from the user U, required electricity is supplied at a venue of an open-air live performance to be held in a place where there is difficulty in supplying electricity. As a specific example, to supply electricity at a predetermined open-air live venue, the user U makes a request for dispatch of a predetermined number of battery electric vehicles (BEVs) or plug-in hybrid electric vehicles (PHEVs) charged to predetermined values or more to the predetermined open-air live venue. When the user U makes the vehicle dispatch request, the vehicle dispatch service device 100 determines whether a vehicle dispatch service of dispatching an electric vehicle capable of supplying a power source is able to be provided in response to the electricity supply request from the user U, on the basis of the position of each of the electric vehicles 200-1 to 200-n, information about the charging state of each of the electric vehicles 200-1 to 200-n, and master information about the open-air live venue designated by the U. Then, the vehicle dispatch service device 100 outputs information instructing dispatch of the electric vehicle capable of providing the vehicle dispatch service and dispatches the vehicle, thereby providing the vehicle dispatch service.

Each of the electric vehicles 200-1 to 200-n generates vehicle notification information including vehicle identification information, vehicle positional information, information indicating the charging state of a vehicle, and vehicle dispatch approval/disapproval information, and transmits the generated vehicle notification information to the vehicle dispatch service device 100. The vehicle dispatch service device 100 receives the vehicle notification information transmitted from each of the electric vehicles 200-1 to 200-n. The vehicle dispatch service device 100 acquires the vehicle identification information, the vehicle positional information, the information indicating the charging state of a vehicle, and the vehicle dispatch approval/disapproval information included in each of one or more of the acquired pieces of vehicle notification information. The vehicle dispatch service device 100 stores the acquired one or more pieces of vehicle identification information, vehicle positional information, information indicating the charging state of a vehicle, and vehicle dispatch approval/disapproval information in association with each other.

Each of the electric vehicles 200-1 to 200-n may or may not be a self-driving vehicle. Using a self-driving vehicle as an electric vehicle to be dispatched makes it possible to pick up more audience members of a live performance or transport materials to be used in the live performance on the way to the open-air live venue.

When the user U requests dispatch of an electric vehicle to the predetermined open-air live venue, the user U performs operation of requesting an electric vehicle using the terminal device 300. When the user U performs the operation of requesting dispatch of an electric vehicle, a vehicle request directed to the predetermined open-air live venue is generated. The terminal device 300 transmits the generated vehicle request to the vehicle dispatch service device 100.

The vehicle dispatch service, device 100 receives the vehicle request transmitted from the terminal device 300, and acquires information about the predetermined open-air live venue included in the received vehicle request. The vehicle dispatch service device 100 specifies information about electricity quantity required in the predetermined open-air live venue using master information about this open-air live venue stored in advance. Then, the vehicle dispatch service device 100 specifies an electric vehicle that can be dispatched to the predetermined open-air live venue on the basis of the specified information.

Next, the vehicle dispatch service device 100 selects the electric vehicle that can be dispatched to the predetermined open-air live venue from the electric vehicles, and generates a vehicle dispatch instruction directed to the vehicle to be dispatched including positional information about the predetermined open-air live venue and information instructing vehicle dispatch to the position of the predetermined open-air live venue. The vehicle dispatch service device 100 transmits the generated vehicle dispatch instruction to the electric vehicle to be dispatched.

The vehicle dispatch service device 100 derives provision time indicating the time when the electric vehicle to be dispatched can be provided to the position of the predetermined open-air live venue on the basis of the position of the electric vehicle to be dispatched and the position of the predetermined open-air live venue. The vehicle dispatch service device 100 generates a vehicle response directed to the terminal device 300 including information indicating that the vehicle dispatch has been instructed and information indicating the provision time, and transmits the generated vehicle response to the terminal device 300.

The following describes the details of the electric vehicles 200-1 to 200-n, the vehicle dispatch service device 100, and the terminal device 300 included in the vehicle system 1. In the following description, an optional electric vehicle belonging to the electric vehicles 200-1 to 200-n will be called an electric vehicle 200.

### Electric Vehicle 200

The electric vehicle 200 included in the vehicle system 1 is a four-wheel mobile unit, for example. The electric vehicle 200 is a battery vehicle including at least a secondary cell and traveling by driving a motor using electric power stored in the secondary cell, or a hybrid vehicle configured to be driven by a motor and to receive power feeding from outside.

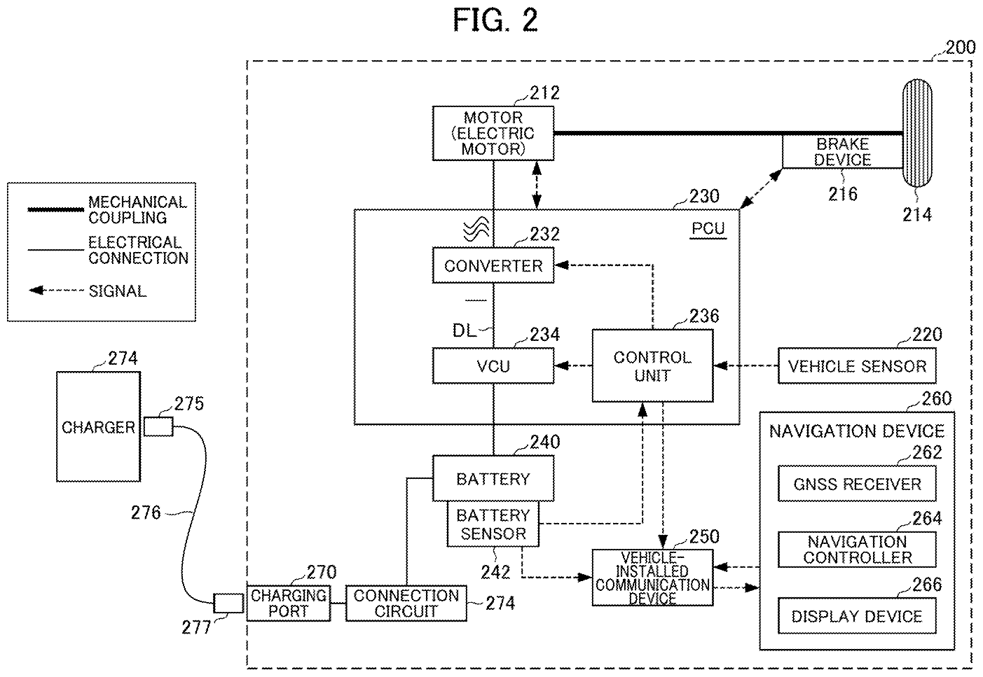

FIG. 2 shows a first example of the configuration of the electric vehicle according to the embodiment. The electric vehicle 200 shown in FIG. 2 is a vehicle which is not a self-driving vehicle. As shown in FIG. 2, the electric vehicle 200 includes a motor 212, a drive wheel 214, a brake device 216, a vehicle sensor 220, a power controller (PCU) 230, a battery 240, a battery sensor 242 that may be a voltage sensor, a current sensor, or a temperature sensor, for example, a vehicle-installed communication device 250, a navigation device 260, a charging port 270, and a connection circuit 272, for example.

The motor 212 is a three-phase AC motor, for example. The motor 212 has a rotor coupled to the drive wheel 214. The motor 212 outputs drive power to the drive wheel 214 using electric power supplied to the motor 212. The motor 212 generates power using the kinetic energy of the electric vehicle during deceleration of the electric vehicle.

The brake device 216 includes a brake caliper, a cylinder that transmits hydraulic pressure to the brake caliper, and an electric motor that generates the hydraulic pressure at the cylinder, for example. The brake device 216 may include a mechanism as a backup to transmit hydraulic pressure generated by operation on a brake pedal to the cylinder through a master cylinder. The brake device 216 is not limited to the configuration described above but may be an electronically-controlled hydraulic brake device that transmits hydraulic pressure at the master cylinder to the cylinder.

The vehicle sensor 220 includes an accelerator position sensor, a vehicle speed sensor, and a brake depression amount sensor. The accelerator position sensor is an example of an operator that accepts an instruction for acceleration from a driver. The accelerator position sensor is attached to an accelerator pedal, detects the amount of operation on the accelerator pedal, and outputs the detected amount of operation on the accelerator pedal as an accelerator position to a control unit 236. The vehicle speed sensor includes wheel speed sensors attached to respective wheels and a speed calculator, for example. The vehicle speed sensor integrates wheel speeds detected by the wheel speed sensors to calculate the speed of the electric vehicle (vehicle speed), and outputs the calculated speed to the control unit 236. The brake depression amount sensor is attached to a brake pedal, detects the amount of operation on the brake pedal, and outputs the detected amount of operation on the brake pedal as a brake depression amount to the control unit 236.

The PCU 230 includes a converter 232, a voltage controller (VCU) 234, and the control unit 236, for example. The configuration of providing these constituting elements in a unified manner as the PCU 230 is merely shown as an example. These constituting elements may be arranged separately.

The converter 232 is an AC-DC converter, for example. The converter 232 has a DC-side terminal connected to a DC link DL. The battery 240 is connected to the DC link DL through the VCU 234. The converter 232 converts an alternating current generated by the motor 212 to a direct current, and outputs the resultant direct current to the DC link DL.

The VCU 234 is a DC-DC converter, for example. The VCU 234 boosts electric power supplied from the battery 240, and outputs the boosted electric power to the DC link DL.

The control unit 236 includes a motor control unit, a brake control unit, and a battery/VCU control unit, for example. The motor control unit, the brake control unit, and the battery/VCU control unit may be replaced with respective separated controllers that may be controllers such as a motor ECU/a brake ECO, and a battery ECU/for example.

The motor control unit controls the motor 212 on the basis of output from the vehicle sensor 220. The brake control unit controls the brake device 216 on the basis of output from the vehicle sensor 220. The battery/VCU control unit calculates the state of charge (SOC) of the battery 240 on the basis of output from the battery sensor 242 attached to the battery 240, and outputs a calculation result about the SOC to the VCU 234 and to the vehicle-installed communication device 250. The SOC is an example of information indicating the charging state of the battery 240. The VCU 234 increases a voltage at the DC link DL in response to an instruction from the battery/VCU control unit.

The battery 240 is a secondary cell such as a lithium-ion cell, for example. The battery 240 stores electric power introduced from a charger 274 outside the electric vehicle 200, and discharges energy for causing the electric vehicle 200 to travel.

The navigation device 260 includes a GNSS receiver 262, a navigation controller 264, and a display device 266, for example. The GNSS receiver 262 measures the position of a machine (the position of the electric vehicle 200) on the basis of a radio wave coining from a GNSS satellite (a GPS satellite, for example). The navigation controller 264 includes a CPU and various types of storage devices, for example, and controls the navigation device 260 entirely. The storage device stores map information (navigation map). The navigation map is a map including roads expressed by nodes and links. On the basis of the position of the electric vehicle 200 measured by the GNSS receiver 262, the navigation controller 264 decides a route to a destination by referring to the navigation map. The destination mentioned herein may be designated using positional information about the electric vehicle 200 included in a vehicle dispatch instruction. The navigation controller 264 may transmit the position of the electric vehicle 200 and a destination to a navigation server (not shown) using the vehicle-installed communication device 250, and acquire a route transmitted as a reply from the navigation server. The route may include information about a stopping point for getting on or getting off by the user U, and an intended arrival time. The navigation controller 264 outputs information about the route decided by any of the foregoing methods to the display device 266. The display device 266 displays the information corresponding to the control by the navigation controller 264. The display device 266 displays a navigation screen in response to the information output from the navigation controller 264. The GNSS receiver 262 outputs positional information corresponding to a measurement result about the position of the electric vehicle 200 to the vehicle-installed communication device 250.

The battery sensor 242 includes a sensor such as a current sensor, a voltage sensor, or a temperature sensor, for example. The battery sensor 242 detects the current value, voltage value, and temperature of the battery 240, for example. The battery sensor 242 outputs the detected current value and voltage value, and information about the detected temperature to the control unit 236 and to the vehicle-installed communication device 250. The battery sensor 242 may include a plurality of sensors, such as a current sensor, a voltage sensor, or a temperature sensor, respectively. In the presence of a plurality of such sensors as the battery sensor 242, a battery sensor identifier may be given to each of a current value, a voltage value, and information indicating a temperature to be output to the control unit 236. The battery sensor identifier is an identifier allowing a plurality of the sensors provided in the electric vehicle 200 to be discriminated from each other. The battery sensor identifier may be expressed by alphanumeric characters determined in advance, for example.

The vehicle-installed communication device 250 includes a wireless module used for making a connection to the Internet, a WAN, a LAN, a public line, a provider device, a dedicated line, or a wireless base station, for example. The vehicle-installed communication device 250 acquires a current value, a voltage value, and information indicating a temperature output from the battery sensor 242. The vehicle-installed communication device 250 acquires a calculation result about an SOC output from the control unit 236. The vehicle-installed communication device 250 acquires positional information about, the electric vehicle 200 output from the GNSS receiver 262. The vehicle-installed communication device 250 generates vehicle notification information directed to the vehicle dispatch service device 100 including the acquired current value, voltage value, and information indicating a temperature, the acquired information indicating the charging state of the electric vehicle 200 such as the SOC, and the acquired positional information about the electric vehicle 200. The vehicle-installed communication device 250 transmits the generated vehicle notification information to the vehicle dispatch service device 100 through the network NW shown in FIG. 1.

The charging port 270 is provided to be pointed toward the outside of the vehicle body of the electric vehicle 200. The charging port 270 is connected to the charger 274 through a charging cable 276. The charging cable 276 includes a first plug 275 and a second plug 277. The first plug 275 is connected to the charger 274, and the second plug 277 is connected to the charging port 270. Electricity from the charger 274 is supplied to the charging port 270 through the charging cable 276. The charger 274 is an example of a charging facility. The charging cable 276 includes a signal cable attached to a power cable. The signal cable mediates communication between the electric vehicle 200 and the charger 274. To achieve this, the first plug 275 and the second plug 277 respectively are provided with a power connector and a signal connector.

The connection circuit 272 is provided, between the charging port 270 and the battery 240. The connection circuit 272 transmits a current such as a DC current, for example, introduced into the connection circuit 272 from the charger 274 through the charging port 270. The connection circuit 272 transmits the DC current to the battery 240.

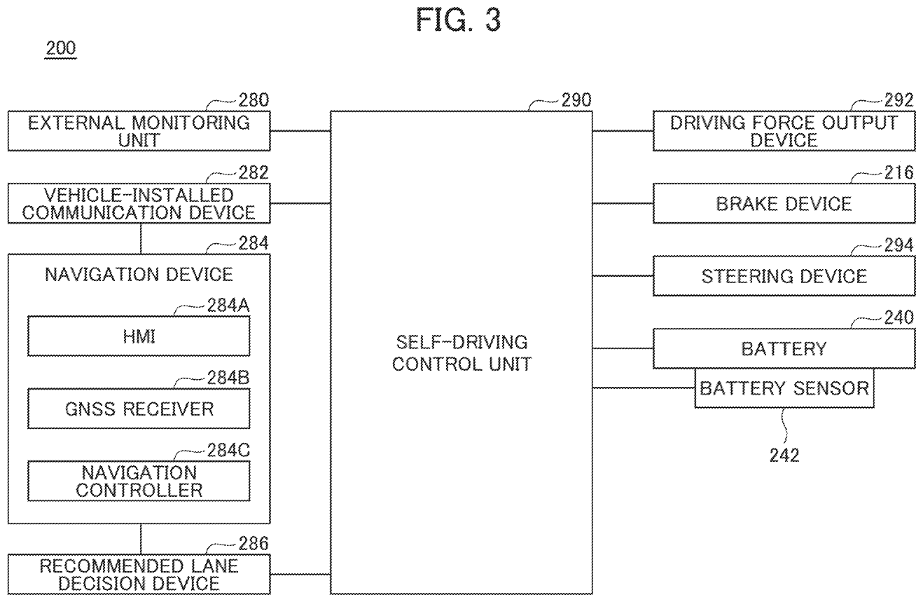

As shown in FIG. 3, the electric vehicle 200 which is a self-driving vehicle includes an external monitoring unit 280, a vehicle-installed communication device 282, a navigation device 284, a recommended lane decision device 286, a self-driving control unit 290, a driving force output device 292, a brake device 216, a steering device 294, a battery 240, and a battery sensor 242, for example.

The external monitoring unit 280 forms a situation acquisition device, and includes a camera, a radar, a light detection and ranging (LIDAR) unit, and an object recognition device that performs sensor fusion process on the basis of outputs from these units, for example. The external monitoring unit 280 estimates the type of an object existing around the electric vehicle 200 (in particular, an electric vehicle, a pedestrian, or a bicycle, for example) to generate estimated information (situation information), and outputs the estimated information together with information about the position or speed of the object to the self-driving control unit 290.

The vehicle-installed communication device 282 is a wireless communication module for making a connection to the network NW or making direct communication with a different electric vehicle or a terminal device of a pedestrian, for example. The vehicle-installed communication device 282 makes wireless communication based on Wi-Fi, dedicated short range communications (DSRC), Bluetooth (registered trademark), or other types of communication standards. Two or more types of devices may be prepared as the vehicle-installed communication device 282. The vehicle-installed communication device 282 acquires a current value, a voltage value, and information indicating a temperature output from the self-driving control unit 290. The vehicle-installed communication device 282 acquires a calculation result about an SOC output from the self-driving control unit 290. The vehicle-installed communication device 282 acquires positional information about the electric vehicle 200 output from a GNSS receiver 284B. The vehicle-installed communication device 282 generates vehicle notification information directed to the vehicle dispatch service device 100 including the acquired current value, voltage value, and information indicating a temperature, the acquired information indicating the charging state of the electric vehicle 200 such as the SOC, the acquired positional information about the electric vehicle 200, and the estimated information generated by the external monitoring unit 280. The vehicle-installed communication device 282 transmits the generated vehicle notification information to the vehicle dispatch service device 100 through the network NW shown in FIG. 1.

The navigation device 284 includes a human machine interface (HMI) 284A, the GNSS receiver 284B, and a navigation controller 284C, for example. The HMI 284A includes a touch-panel display device, a speaker, a microphone, etc., for example. The GNSS receiver 284B measures the position of a machine (the position of the electric vehicle 200) on the basis of a radio wave coming from a GNSS satellite (a GPS satellite, for example). The navigation controller 284C includes a CPU and various types of storage devices, for example, and controls the navigation device 284 entirely. The storage device stores map information (navigation map). The navigation map is a map including roads expressed by nodes and links. On the basis of the position of the electric vehicle 200 measured by the GNSS receiver 284B, the navigation controller 284C decides a route to a destination by referring to the navigation map. The destination mentioned herein may be designated using the HMI 284A or may foe designated using positional information about the electric vehicle 200 included in a vehicle dispatch instruction. The navigation controller 284C may transmit the position of the electric vehicle 200 and the predetermined open-air live venue which is a destination to a navigation server (not shown) using the vehicle-installed communication device 282, and acquire a route transmitted as a reply from the navigation server. The route may include information about a stopping point for getting on or getting off by an owner of the electric vehicle 200, and an intended arrival time. The navigation controller 284C outputs information about the route decided by any of the foregoing methods to the recommended lane decision device 286.

The recommended lane decision device 286 includes a map positioning unit (MPU) and various types of storage devices, for example. The storage device includes highly accurate map information covering further details than the navigation map. The highly accurate map information includes information such as a road width, a grade, a curvature, and positions of signals about each lane, for example. The recommended lane decision device 286 decides a recommended lane preferable for traveling along a route input from the navigation device 284, and outputs the decided recommended lane to the self-driving control unit 290.

The self-driving control unit 290 includes one or more processors such as a CPU or an MPU, and various types of storage devices. On the principle of traveling along the recommended lane decided by the recommended lane decision device 286, the self-driving control unit 290 causes the electric vehicle 200 to travel automatically in such a manner as to avoid contact with an object at a position or speed input from the external monitoring unit 280. The self-driving control unit 290 performs various types of events sequentially, for example. The events include a constant-speed traveling event of traveling along one traveling lane at a constant speed, a tracking traveling event of traveling while tracking a vehicle traveling ahead, a lane changing event, a merging event, a branching event, an emergency stopping event, a tollgate event for passing through a tollgate, and a handover event for finishing self-driving and making a switch to manual driving, for example. During implementations of these events, action for the avoidance may be planned on the basis of a situation around the electric vehicle 200 (the presence of a neighboring vehicle or pedestrian, lane narrowing resulting from a roadwork, for example).

The self-driving control unit 290 generates an intended orbit in which the electric vehicle 200 is to travel in the future. The intended orbit includes a speed element, for example. For example, the intended orbit is expressed by a line of sequentially arranged points (orbital points) to be reached by the electric vehicle 200. The orbital points are points to be reached by the electric vehicle 200 and are defined at a predetermined traveling distance. Separately from the orbital points, an intended speed and an intended acceleration defined for each predetermined sampling period (a few tenths of a second, for example) are generated as part of the intended orbit. The orbital points may be positions to be reached by the electric vehicle 200 at the time of sampling in each predetermined period of the sampling. In this case, information such as an intended speed and an intended acceleration is expressed using an interval between the orbital points. The self-driving control unit 290 calculates the SOC of the battery 240 on the basis of output from the battery sensor 242 attached to the battery 240, and outputs a calculation result about the SOC to the vehicle-installed communication device 282. The self-driving control unit 290 outputs a current value, a voltage value, and information indicating a temperature output from the battery sensor 242 to the vehicle-installed communication device 282.

The battery 240 is a secondary cell such as a lithium-ion cell, for example. The battery 240 stores electric power introduced from a charger outside the electric vehicle 200, and discharges energy for causing the electric vehicle 200 to travel.

The battery sensor 242 includes a sensor such as a current sensor, a voltage sensor, or a temperature sensor, for example. The battery sensor 242 detects the current value, voltage value, and temperature of the battery 240, for example. The battery sensor 242 outputs the detected current value and voltage value, and information about the detected temperature to the self-driving control unit 290. The battery sensor 242 may include a plurality of sensors, such as a current sensor, a voltage sensor, or a temperature sensor, respectively. In the presence of a plurality of such sensors as the battery sensor 242, a battery sensor identifier may be given to each of a current value, a voltage value, and information indicating a temperature to be output to the self-driving control unit 290. The battery sensor identifier is an identifier allowing a plurality of the sensors provided in the electric vehicle 200 to be discriminated from each other. The battery sensor identifier may be expressed by alphanumeric characters determined in advance, for example.

An example of a self-driving operation process by the electric vehicle 200 will be described. First, the navigation device 284 decides a route. This route is a rough route without distinction of lanes, for example. Next, the recommended lane decision device 286 decides a recommended lane that facilitates traveling along the route. Then, the self-driving control unit 290 generates orbital points for traveling along the recommended lane as correctly as possible while avoiding an obstacle, for example, and controls some or ail of the driving force output device 292, the brake device 216, and the steering device 294 in order to achieve traveling along the orbital points (and along an accompanying speed profile). Such role sharing is merely shown as an example. The self-driving control unit 290 may perform the process in a centralized manner, for example.

The driving force output device 292 outputs traveling driving force (torque) to drive wheels for causing the electric vehicle to travel. The driving force output device 292 includes a combination of an internal combustion engine, a motor, and a transmission, etc., and a power ECU for controlling these units, for example. The power ECU controls the configuration described above in response to information input from the self-driving control unit 290 or information input from a driving operator not shown.

The brake device 216 includes a brake caliper, a cylinder that transmits hydraulic pressure to the brake caliper, an electric motor that generates the hydraulic pressure at the cylinder, and a brake ECU, for example. The brake ECU controls the electric motor in response to information input from the self-driving control unit 290 or information input from a driving operator, and causes a brake torque responsive to a braking operation to be output to each wheel. The brake device 216 may include a mechanism as a backup to transmit hydraulic pressure generated by operation on a brake pedal included in the driving operator to the cylinder through a master cylinder. The brake device 216 is not limited to the configuration described above but may be an electronically-controlled hydraulic brake device that controls an actuator in response to information input from the self-driving control unit 290 and transmits hydraulic pressure at the master cylinder to the cylinder.

The steering device 294 includes a steering ECU and an electric motor, for example. The electric motor causes force to act on a rack-and-pinion mechanism to change the direction of a turning wheel, for example. The steering ECU drives the electric motor in response to information input from the self-driving control unit 290 or information input from a driving operator, and changes the direction of the turning wheel.

### Vehicle Dispatch Service Device 100

The vehicle dispatch service device 100 is realized using a device such as a personal computer, a server, or an industrial computer, for example. The vehicle dispatch service device 100 includes a communication unit 110, an acceptance unit 120, a determination unit 130, a management unit 140, a derivation unit 150, and a storage unit 160, for example.

The communication unit 110 is realized using a communication module. More specifically, the communication unit 110 is configured using a device to make wire communication. The communication unit 110 may be configured using a wireless device to make wireless communication by a wireless communication technique such as LTE or a wireless LAN, for example. The communication unit 110 communicates through the network NW with the terminal device 300, with the vehicle-installed communication device 250 in the electric vehicle 200 which is not a self-driving vehicle, and with the vehicle-installed communication device 282 in the electric vehicle 200 which is a self-driving vehicle. More specifically, the communication unit 110 receives vehicle notification information transmitted from the vehicle-installed communication device 250 in the electric vehicle 200 which is not a self-driving vehicle and vehicle notification information transmitted from the vehicle-installed communication device 282 in the electric vehicle 200 which is a self-driving vehicle, and outputs the received vehicle notification information to the acceptance unit 120. The communication unit 110 receives a vehicle request transmitted from the terminal device 300, and outputs the received vehicle request to the acceptance unit 120. The communication unit 110 acquires a vehicle dispatch instruction output from the management unit 140, and transmits the acquired vehicle dispatch instruction to the electric vehicle 200 to be dispatched. The communication unit 110 acquires a vehicle response output from the management unit 140, and transmits the acquired vehicle response to the terminal device 300.

The storage unit 160 is realized using a hard disk drive (HDD), a flash memory, a random access memory (RAM), or a read only memory (ROM), for example. The storage unit 160 stores vehicle information 161, user information 162, and vehicle notification information 164. The vehicle information 161, the user information 162, and the vehicle notification information 164 may be stored on the cloud.

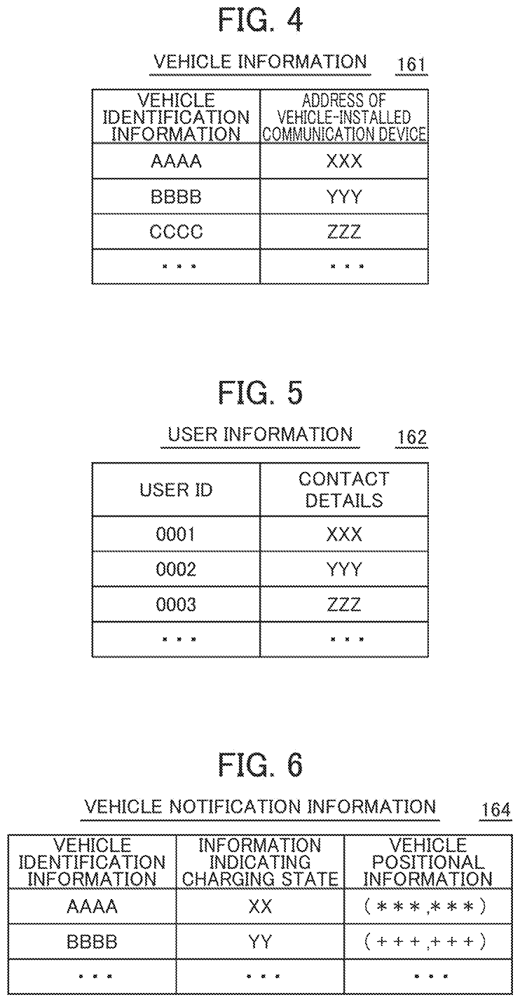

FIG. 4 shows an example of vehicle information. The vehicle information 161 is information in a table format including vehicle identification information about the electric vehicle 200 and an address of a vehicle-installed communication device installed on the electric vehicle 200 stored in association with each other. An example of an address of the vehicle-installed communication device is an IP address. In the example shown in FIG. 4, the vehicle information 161 includes vehicle identification information “AAAA” about the electric vehicle 200 and an address “XXX” of a vehicle-installed communication device stored in association with each other, vehicle identification information “BBBB” about the electric vehicle 200 and an address “YYY” of a vehicle-installed communication device stored in association with each other, and vehicle identification information “CCCC” about the electric vehicle 200 and an address “ZZZ” of a vehicle-installed communication device stored in association with each other. These pieces of information are registered at the time of introduction of the electric vehicle 200 into the vehicle system 1.

FIG. 5 shows an example of user information. The user information 162 is information in a table format including a user ID and contact details with the user U corresponding to the user ID stored in association with each other. An example of contact details with the user D is an e-mail address. In the example shown in FIG. 5, the user information 162 includes a user ID “0001” and contact details “XXX” stored in association with each other, a user ID “0002” and contact details “YYY” stored in association with each other, and a user ID “0003” and contact details “ZZZ” stored in association with each other. These pieces of information are registered when the user U starts using the vehicle system 1.

FIG. 6 shows an example of vehicle notification information. The vehicle notification information 164 is information in a table format including vehicle Identification information about the electric vehicle 200, information indicating the charging state of the electric vehicle 200, and vehicle positional information about the electric vehicle 200 stored in association with each other. An example of vehicle positional information about the electric, vehicle 200 is expressed as (longitude, latitude). In the example shown in FIG. 6, the vehicle notification information 164 includes vehicle identification information “AAAA” about the electric vehicle 200, information “XX” indicating the charging state of the electric vehicle 200, and vehicle positional information “(***, ***)” about the electric vehicle 200 stored in association with each other, and vehicle identification .information “BBBB” about the electric vehicle 200, information “YY” indicating the charging state of the electric vehicle 200, and vehicle positional information “(+++, +++)” about the electric vehicle 200 stored in association with each other. The information “XX” indicating the charging state of the electric vehicle 200 is the state of charge of a secondary cell (battery 240) in the electric vehicle 200, for example. These pieces of information are updated on the basis of vehicle notification information transmitted from the electric vehicle 200.

The acceptance unit 120, the determination unit 130, the management unit 140, and the derivation unit 150 are realized by causing a hardware processor such as a central processing unit (CPU) to execute a program (software) stored in the storage unit 160, for example. Some or all of these functional units may be realized using hardware (circuit section including circuitry) such as a large scale integration (LSI), an application specific integrated circuit (ASIC), a field-programmable gate array (FPGA), or a graphics processing unit (GPU), for example, or may be realized by causing software and hardware working cooperatively. The program may be stored in advance in a storage device (a storage device with a non-transitory storage medium) such as a hard disk drive (HDD) or a flash memory. Alternatively, the program may be stored in an attachable/detachable storage medium (a non-transitory storage medium) such as a DVD or a CD-ROM, and may be installed by attaching the storage medium to a drive.

Processes described separately in the following to be performed by the acceptance unit 120, the determination unit 130, the management unit 140, and the derivation unit 150 include a process to be performed before the user U requests dispatch of an electric vehicle, and a process to be performed after the user U requests dispatch of the electric vehicle by operating the terminal device 300.

Described first is the process to be performed before the user U requests dispatch of a vehicle to the predetermined open-air live venue. The vehicle-installed communication device 250 of the electric vehicle 200 acquires vehicle identification information, information indicating a charging state, and positional information about the electric vehicle 200, and generates vehicle notification information directed to the vehicle dispatch service device 100 including the acquired vehicle identification information, information indicating a charging state, and positional information about the electric vehicle 200. The vehicle-installed communication device 250 transmits the generated vehicle notification information to the vehicle dispatch service device 100. The communication unit 110 of the vehicle dispatch service device 100 receives the vehicle notification information transmitted from the vehicle-installed communication device 250, and outputs the received vehicle notification information to the acceptance unit 120.

The vehicle-installed communication device 282 of the electric vehicle 200 acquires vehicle identification information, information indicating a charging state, and positional information about the electric vehicle 200, and generates vehicle notification information directed to the vehicle dispatch service device 100 including the acquired vehicle identification information, information indicating a charging state, and positional information about the electric vehicle 200. The vehicle-installed communication device 282 transmits the generated vehicle notification information to the vehicle dispatch service device 100. The communication unit 110 of the vehicle dispatch service device 100 receives the vehicle notification information transmitted from the vehicle-installed communication device 282, and outputs the received vehicle notification information to the acceptance unit 120.

The acceptance unit 120 acquires the vehicle notification information output from the communication unit 110, and acquires the vehicle identification information, the information indicating a charging state, and the positional information about the electric vehicle 200 included in the acquired vehicle notification information. The acceptance unit 120 stores the acquired vehicle identification information, information indicating a charging state, and positional information about the electric vehicle 200 in association with each other into the vehicle notification information 164 in the storage unit 160.

The storage unit 160 stores master Information about the predetermined open-air live venue which is a destination of dispatch of an electric vehicle to be requested by the user U. The master information includes positional information about the open-air live venue, information about the quantity of electricity usage required in the open-air venue, etc.

Described next is the process to be performed after the user U requests vehicle dispatch to the predetermined open-air live venue by operating the terminal device 300. The terminal device 300 generates a vehicle request (request for vehicle dispatch) directed to the vehicle dispatch service device 100 including information indicating that vehicle dispatch to the predetermined open-air live venue is requested. The terminal device 300 transmits the generated vehicle request to the vehicle dispatch service device 100.

The acceptance unit 120 acquires the vehicle request output from the communication unit 110, and outputs the acquired vehicle request to the determination unit 130. The determination unit 130 acquires the vehicle request output from the acceptance unit 120, and acquires vehicle identification information included in the acquired vehicle request. On the basis of vehicle positional information associated with the acquired vehicle identification information and information indicating a charging state associated with vehicle identification information other than the former vehicle identification information, the determination unit 130 determines whether there is a charged electric vehicle available to the user U using the vehicle notification information 164 in the storage unit 160.

More specifically, on the basis of vehicle positional information acquired from the vehicle notification information 164, the determination unit 130 determines whether the predetermined open-air live venue is located in an area to which a vehicle can be dispatched. On the basis of the vehicle positional information acquired from the vehicle notification information 164 and positional information about the open-air live venue stored in the storage unit 160, the determination unit 130 derives a distance between the electric vehicle 200 and the predetermined open-air live venue. If the derived distance between the electric vehicle 200 and the predetermined open-air live venue is equal to or less than a distance threshold, the determination unit 130 determines that vehicle dispatch service is available to the user U. If the derived distance between the vehicle dispatch service device 100 and the predetermined open-air live venue is greater than the distance threshold, or if vehicle dispatch approval/disapproval information included in the vehicle notification information stored in the electric vehicle 200 includes information indicating rejection of vehicle dispatch, the determination unit 130 determines that vehicle dispatch is not available to the user U. The distance threshold mentioned herein is determined in response to a range allowing dispatch from the position of the electric vehicle 200 to the open-air live venue. The vehicle dispatch approval/disapproval information is information input in advance by an owner of the electric vehicle 200 to the electric vehicle 200 indicating approval or disapproval of dispatch of the electric vehicle 200. If the owner of the electric vehicle 200 does not approve dispatch of the electric vehicle 200 by the vehicle dispatch service device 100 to the open-air live venue, information indicating “disapproval” is stored as the vehicle dispatch approval/disapproval information into the electric vehicle 200. Conversely, if the owner of the electric vehicle 200 approves dispatch of the electric vehicle 200 by the vehicle dispatch service device 100 to the open-air live venue, information indicating “approval” is stored as the vehicle dispatch approval/disapproval information into the electric vehicle 200. The electric vehicle 200 with information “approval” stored as the vehicle dispatch approval/disapproval information is selectable by the determination unit 130.

The management unit 140 generates a vehicle dispatch instruction including the vehicle positional information and information instructing vehicle dispatch to the position of the predetermined open-air live venue. The management unit 140 outputs the generated vehicle dispatch instruction to the communication unit 110. The management unit 140 outputs the vehicle dispatch instruction to the derivation unit 150. The derivation unit 150 acquires positional information about the predetermined open-air live venue output from the management unit 140, and derives provision time on the basis of the acquired positional information about the predetermined open-air live venue and vehicle positional information about the electric vehicle to be dispatched. The derivation unit 150 outputs information indicating the derived provision time to the management unit 140. The management unit 140 acquires the Information indicating the provision time output from the derivation unit 150. The management unit 140 acquires a contact details stored in association with the user U from the user information 162 in the storage unit 160. The management unit 140 generates a vehicle response directed to the contact details (here, the terminal device 300) including information indicating that the vehicle dispatch has been instructed and information indicating the provision time. The management unit 140 outputs the generated vehicle response to the communication unit 110.

If the determination unit 130 determines on the basis of the distance between the electric vehicle 200 and the predetermined open-air live venue or vehicle dispatch approval/disapproval information that vehicle dispatch service is not available to the user U, the determination unit 130 generates a vehicle response directed to the terminal device 300 including information indicating the unavailability of the service. The management unit 140 outputs the generated vehicle response to the communication unit 110.

### Terminal Device

The terminal device 300 is a smartphone, a tablet terminal, or a personal computer, for example. In the terminal device 300, an application program or a browser, for example, for using the vehicle system 1 is started to support the service described above. The terminal device 300 is a smartphone, for example, and it is assumed that the application program (app for use of vehicle dispatch service) is running. The app for service use communicates with the vehicle dispatch service device 100 in response to operation by the user U, and gives a push notification based on a vehicle response received from the vehicle dispatch service device 100.

### Operation of Vehicle System, Vehicle Dispatch Service Method, and Program for Causing Vehicle Dispatch Service Device to Operate to Implement Vehicle Dispatch Service Method

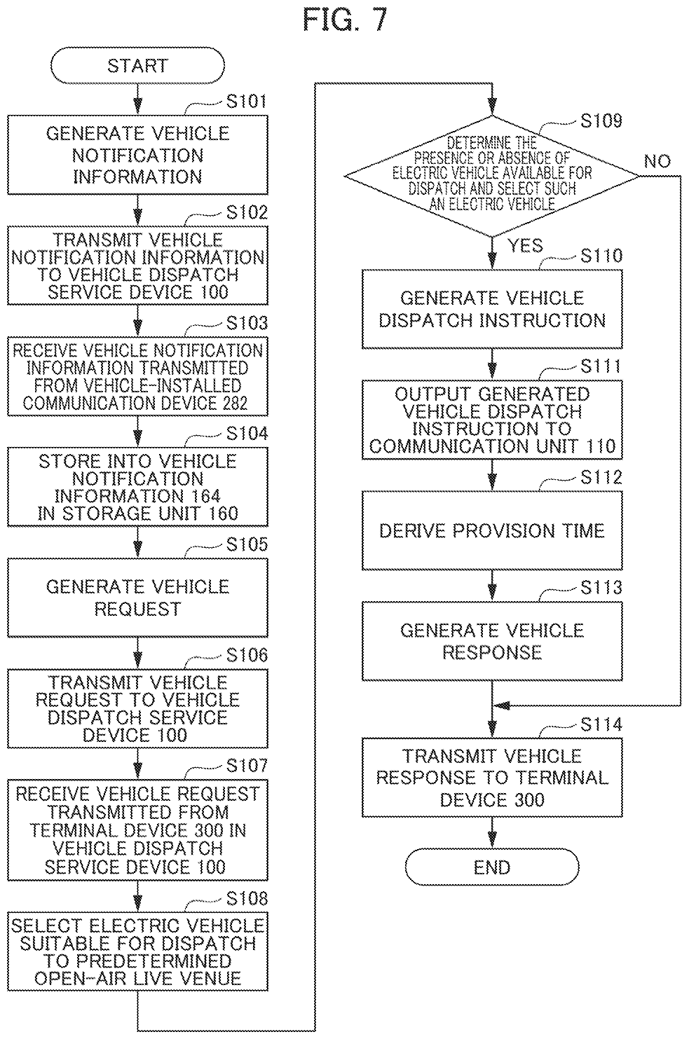

FIG. 7 is a flowchart showing control relating to the vehicle dispatch service device 100.

In the electric vehicle 200-1, the vehicle-installed communication device 250 acquires positional information about the electric vehicle 200-1 output from the GNSS receiver 262, an SOC output from the control unit 236, and a current value, a voltage value, and information indicating a temperature output from the battery sensor 242. The vehicle-installed communication device 250 generates vehicle notification information directed to the vehicle dispatch service device 100 including the acquired positional information, current value, voltage value, information indicating a temperature, information indicating a charging state such as the SOC about the electric vehicle 200-1 (step S101).

In the electric vehicle 200-1, the vehicle-installed communication device 250 transmits the generated vehicle notification information to the vehicle dispatch service device 100 (step S102).

In the vehicle dispatch service device 100, the communication unit 110 receives the vehicle notification information transmitted from the vehicle-installed communication device 250 (step S103).

In the vehicle dispatch service device 100, the communication unit 110 outputs the received vehicle notification information to the acceptance unit 120. The acceptance unit 120 acquires the vehicle notification information output from the communication unit 110, and acquires vehicle identification information, vehicle positional information, and information indicating a charging state included in the acquired vehicle notification information. The acceptance unit 120 stores the acquired vehicle identification information, vehicle positional information, and information indicating a charging state in association with each other into the vehicle notification information 164 in the storage unit 160 (step S104). In each of the electric vehicles from 200-2 to 200-n-1, processes similar to those in steps S101 to S104 are also performed. In the following description of similar steps, the similar steps will be given the same step numbers starting from “S”.

In the electric vehicle 200-n, the vehicle-installed communication device 282 acquires positional information about the electric vehicle 200-n output from the GNSS receiver 284B, an SOC output from the self-driving control unit 290, and a current value, a voltage value, and information indicating a temperature. The vehicle-installed communication device 282 generates vehicle notification information directed to the vehicle dispatch service device 100 including the acquired positional information, current value, voltage value, information indicating a temperature and information indicating a charging state such as the SOC about the electric vehicle 200-n (step S101).

In the electric vehicle 200-n, the vehicle-installed communication device 282 transmits the generated vehicle notification information to the vehicle dispatch service device 100 (step S102).

In the vehicle dispatch service device 100, the communication unit 110 receives the vehicle notification information transmitted from the vehicle-installed communication device 282 (step S103).

In the vehicle dispatch .service device 100, the communication unit 110 outputs the received vehicle notification information to the acceptance unit 120. The acceptance unit 120 acquires the vehicle notification information output from the communication unit 110, and acquires vehicle identification Information, vehicle positional information, and information indicating a charging state included in the acquired vehicle notification information. The acceptance unit 120 stores the acquired vehicle identification information, vehicle positional information, and information indicating a charging state in association with each other into the vehicle notification information 164 in the storage unit 160 (step S104).

The user U performs operation on the terminal device 300 to request an electric vehicle. When the user U performs the operation to request an electric vehicle, the terminal device 300 generates a vehicle request directed to the vehicle dispatch service device 100 including master information about the predetermined open-air live venue and reward information about a reward for power feeding to be paid to the electric vehicle to be dispatched (step S105).

The terminal device 300 transmits the generated vehicle request to the vehicle dispatch service device 100 (step S106).

In the vehicle dispatch service device 100, the communication unit 110 receives the vehicle request transmitted from the terminal device 300 (step S107).

In the vehicle dispatch service device 100, the communication unit 110 outputs the received vehicle request to the acceptance unit 120. The acceptance unit 120 acquires the vehicle request output from the communication unit 110, and outputs the acquired vehicle request to the determination unit 130. The determination unit 130 acquires the vehicle request output from the acceptance unit 120, and acquires vehicle identification information included in the acquired vehicle request. On the basis of vehicle positional information associated with the acquired vehicle identification information, information indicating a charging state associated with vehicle identification information other than the former vehicle identification information, master information about the predetermined open-air live venue designated by the user U (including reward information), and vehicle dispatch approval/disapproval information, the determination unit 130 selects an electric vehicle suitable for dispatch to the predetermined open-air live venue from the vehicle notification information 164 in the storage unit 160 (step S108).

Then, the determination unit 130 determines the presence or absence of each of selected electric vehicles in a set (if only one electric vehicle is selected, the determination unit 130 determines the presence or absence of the one selected electric vehicle). Here, the description continues on the assumption that the determination unit 130 determines that there is one or there are several electric vehicles available to the user U. The determination unit 130 outputs one or several pieces of extracted vehicle identification information to the management unit 140 (step S109: YES). If the determination unit 130 determines that there is no electric vehicle satisfying the request from the user U, the determination unit 130 generates a vehicle response directed to the terminal device 300 including information indicating the unavailability of the service. The management unit 140 outputs the generated vehicle response to the communication unit 110 (step S109: NO). The communication unit 110 acquires the vehicle response output from the determination unit 130, and transmits the acquired vehicle response to the terminal device 300.

In the vehicle dispatch service device 100, the management unit 140 acquires the one or several pieces of vehicle identification information output from the determination unit 130. The management unit 140 selects any of the acquired one or several pieces of vehicle identification information to select an electric vehicle to be dispatched. The management unit 140 acquires an address of the vehicle-installed communication device 250 or an address of the vehicle-installed communication device 282 stored in association with the selected vehicle identification information from the vehicle information 161 in the storage unit 160. The management unit 140 generates a vehicle dispatch instruction directed to the acquired address including vehicle positional information and reward information about a reward for power feeding (step S110).

In the vehicle dispatch service device 100, the management unit 140 outputs the generated vehicle dispatch instruction to the communication unit 110 (step S111). The communication unit 110 acquires the vehicle dispatch instruction output from the management unit 140, and transmits the acquired vehicle dispatch instruction to the selected electric vehicle.

In the vehicle dispatch service device 100, the management unit 140 outputs positional information about the predetermined open-air live venue to the derivation unit 150. The derivation unit 150 acquires the positional information about the predetermined open-air live venue output from the management unit 140, and derives provision time on the basis of the acquired positional Information about the predetermined open-air live venue and vehicle positional information about the electric vehicle to be dispatched (step S112).

In the vehicle dispatch service device 100, the derivation unit 150 outputs information indicating the derived provision time to the management unit 140. The management unit 140 acquires the information indicating the derived provision time output from the derivation unit 150. The management unit 140 generates a vehicle response directed to the terminal device 300 including information indicating that the vehicle dispatch has been instructed and the information indicating the provision time (step S113).

In the vehicle dispatch service device 100, the management unit 140 outputs the generated vehicle response to the communication unit 110. The communication unit 110 acquires the vehicle response output from the management unit 140, and transmits the acquired vehicle response to the terminal device 300 (step S114). As a result of the foregoing, the selected electric vehicle is dispatched to the predetermined open-air live venue designated by the user U, and the selected electric vehicle arrives at the predetermined open-air live venue at the provision time. In the electric vehicle, the reward information about a reward for power feeding included in the vehicle dispatch instruction is displayed to allow check of a reward for power feeding to the predetermined open-air live venue resulting from the present vehicle dispatch.

The embodiment achieves the following effect. According to the embodiment, the storage unit 160 stores the vehicle notification information 164 received by the communication unit 110 including identification information about the electric vehicle 200, positional information about the electric vehicle 200, and information indicating the charging state of the electric vehicle 200. On the basis of a vehicle request received by the communication unit 110 from the terminal device 300 of a user and the vehicle notification information 164 stored in the storage unit 160 and including vehicle dispatch approval/disapproval information, it is determined whether a service of dispatching the electric vehicle 200 capable of supplying a power source is able to be provided in response to a request for supply of electricity from the user U. If the service of dispatching the electric vehicle 200 is determined to be able to be provided, information instructing dispatch of the electric vehicle 200 determined to be capable of providing the vehicle dispatch service is output.

Thus, it becomes possible to devise a match between the user U requesting supply of electricity in a place where there is difficulty in supplying electricity such as a riverside barbecue place, a region of an emergency area power outage, or an open-air live venues, for example, and the electric vehicle 200 capable of supplying electricity. As a result, it becomes possible to supply electricity in the place where there is difficulty in supplying electricity, while an owner of the electric vehicle 200 to supply electricity is allowed to obtain a reward for supply of electricity.

The determination unit 130 determines whether a required number of electric vehicles 200 is able to be dispatched in response to the request for supply of electricity from the user U. This allows the user U to be notified of whether vehicle dispatch satisfying the request from the user U is available. As a result, the user U becomes capable of seeing whether the user U can actually request vehicle dispatch.

The vehicle request includes reward information about a reward for the electric vehicle 200. This allows an owner of the electric vehicle 200 to determine whether vehicle dispatch approval/disapproval information about the electric vehicle 200 is to be “approval” or “disapproval” information by taking the reward information into consideration.

The present invention is not limited to the embodiment described above but the present invention also includes modifications, improvements, etc. within a range in which the purpose of the present invention is attainable. For example, the configurations of units including a communication unit, an acceptance unit, a determination unit, and a management unit are not limited to the configurations of the units of the embodiment including the communication unit 110, the acceptance unit 120, the determination unit 130, and the management unit 140.

### EXPLANATION OF REFERENCE NUMERALS

1 . . . vehicle system
100 . . . vehicle dispatch service device
110 . . . communication unit
120 . . . acceptance unit
130 . . . determination unit
140 . . . management unit
150 . . . derivation unit
160 . . . storage unit
161 . . . vehicle information
162 . . . user information
164 . . . vehicle notification information
200-1 to 200-n, 200 . . . electric vehicle

What is claimed is:

1. A vehicle dispatch service device comprising:
a communication unit that makes communication with a vehicle-installed communication device and with a terminal device of a user;
an acceptance unit that stores vehicle notification information received by the communication unit into a storage unit, the vehicle notification information including identification information about an electric vehicle, positional information about the electric vehicle, and information indicating a charging state of the electric vehicle;
a determination unit that determines whether a service of dispatching an electric vehicle capable of supplying a power source is able to be provided in response to a request for supply of electricity from the user, on the basis of a vehicle request received by the communication unit from the terminal device of the user and the vehicle notification information stored in the storage unit and including vehicle dispatch approval/disapproval information; and
a management unit that outputs information instructing dispatch of the electric vehicle determined to be capable of providing the vehicle dispatch service if the determination unit determines that the service of dispatching the electric vehicle is able to be provided.

2. The vehicle dispatch service device according to claim 1, wherein the determination unit determines whether a required number of electric vehicles is able to be dispatched in response to the request for supply of electricity from the user.

3. The vehicle dispatch service device according to claim 1, wherein the vehicle request includes reward information about a reward for the electric vehicle.

4. A vehicle dispatch service method implemented by a vehicle dispatch service device comprising a communication unit that makes communication with a vehicle-installed communication device and with a terminal device of a user, the method comprising:
storing vehicle notification information received by the communication unit into a storage unit, the vehicle notification information including identification information about an electric vehicle, positional information about the electric vehicle, and information indicating a charging state of the electric vehicle;
determining whether a service of dispatching an electric vehicle capable of supplying a power source is able to be provided in response to a request for supply of electricity from the user, on the basis of a vehicle request received by the communication unit from the terminal device of the user and the vehicle notification information stored in the storage unit and including vehicle dispatch approval/disapproval information; and
outputting information instructing dispatch of the electric vehicle determined to be capable of providing the vehicle dispatch service if the service of dispatching the electric vehicle is determined to be able to be provided.

5. A non-transitory computer-readable medium storing a program for causing a vehicle dispatch service device to perform a process, the vehicle dispatch service device comprising a communication unit that makes communication with a vehicle-installed communication device and with a terminal device of a user, the process comprising:
storing vehicle notification information received by the communication unit into a storage unit, the vehicle notification information including identification information about an electric vehicle, positional information about the electric vehicle, and information indicating a charging state of the electric vehicle;
determining whether a service of dispatching an electric vehicle capable of supplying a power source is able to be provided in response to a request for supply of electricity from the user, on the basis of a vehicle request received by the communication unit from the terminal device of the user and the vehicle notification information stored in the storage unit and including vehicle dispatch approval/disapproval information; and
outputting information instructing dispatch of the electric vehicle determined to be capable of providing the vehicle dispatch service if the service of dispatching the electric vehicle is determined to be able to be provided.
